(19) United States
(12) Patent Application Publication
(10) Pub. No.: US 2009/0145098 A1
(43) Pub. Date: Jun. 11, 2009

(54) AGRICULTURAL MACHINE FOR RAKING AGRICULTURAL PRODUCTS

(75) Inventor: Carletto TONUTTI, Tricesimo (IT)

Correspondence Address: Novak Druce + Quigg, LLP, 1300 Eye Street, NW, Suite 1000, Suite 1000, West Tower, Washington, DC, 20005, US

(73) Assignee: TONUTTI SPA INDUSTRIA MACCHINE AGRICOLE, Remanzacco (IT)

(21) Appl. No.: 12/327,542

(22) Filed: Dec. 3, 2008

(30) Foreign Application Priority Data
Dec. 6, 2007 (IT) UD2007A000232

(51) Int. Cl. A01D 78/14

(52) U.S. Cl. 56/377

(57) ABSTRACT

An agricultural machine for raking an agricultural product, comprising a frame provided with a first part connected to a drawing means, and a second part connected to the first part in order to support a plurality of operating tools of a rotary type, each of which is positioned so as to define a determinate angle of incidence (α) with respect to the ground, in order to perform a determinate thrust action on the agricultural product. The agricultural machine also comprises an adjustment device provided with a pivoting member constrained both to the first part and also to the second part of the frame to allow the selective rotation of the second part with respect to the first part, around an axis of pivoting (X) substantially parallel to the ground, so as to selectively vary the amplitude of the angle of incidence (α) of the operating tools with respect to the ground.

### FIELD OF THE INVENTION

The present invention concerns an agricultural machine of the type able to be drawn by a tractor, in order to rake a mass of hay, forage or other agricultural products, and to gather it together in order in one or more swaths. In particular, the agricultural machine according to the present invention comprises a frame on which a plurality of star-shaped wheels are mounted rotatable, and exert an elastic thrust on the hay in order to gather it together. The agricultural machine according to the present invention allows to vary the angle of incidence of the star-shaped wheels with respect to the ground, so as to vary the intensity of their action on the hay.

### BACKGROUND OF THE INVENTION

Agricultural machines are known, called swathers, used to form swaths of hay after mowing.

Known swathers comprise a trolley-like frame able to be connected to a tractor and provided with a plurality of operating tools, or so-called star-shaped wheels.

Each wheel consists of a plurality of radial teeth that carry out an action of elastic thrust on the hay, in order to form the swath.

Linear frames are known, in which the wheels are disposed in succession on a plurality of arms hinged to the frame.

Frames with bilateral arms are also known, so-called V-shaped, in which each arm of the frame supports a plurality of wheels so as to convey the hay toward the center of the swather and thus form a central swath.

In both known solutions it is necessary to vary both the width of the swath and the intensity of thrust of the star-shaped wheels on the hay, simply and quickly, for example according to the type of ground, the humidity, the type of hay, or other factors, in order to optimize the formation of the swath.

It is known to provide different sets of star-shaped wheels, interchangeable on each occasion, in order to optimize the thrust action on the hay, in which each set has wheels with teeth of different diameter and elasticity.

This known solution, especially due to the high number of wheels provided on each frame, entails high costs of production and design, and also requires long and complex interventions during operations by specialized personnel in order to replace the wheels.

Furthermore, with particular reference to known swathers with V-shaped frames, in order to adjust the width of the swath formed centrally, it is known to modify the width of the rear part of the frame in order to bring the two arms reciprocally closer to, or distance them from, each other.

This known solution requires long and complex equipping steps, which need the rear part of the frame to be partly dismantled, with a considerable increase in the production times.

One purpose of the present invention is to achieve an agricultural machine which is simple and economical to make, and which allows to adjust the intensity of the action of the star-shaped wheels on the hay, in a simple, quick and effective manner.

Another purpose of the present invention is to achieve an agricultural machine which allows to adjust the width of the swath formed, reducing the equipping times and without needing to at least partly dismantle any components of the frame.

The Applicant has devised, tested and embodied the present invention to overcome the shortcomings of the state of the art and to obtain these and other purposes and advantages.

### SUMMARY OF THE INVENTION

The present invention is set forth and characterized in the independent claim, while the dependent claims describe other characteristics of the invention or variants to the main inventive idea.

In accordance with the above purposes an agricultural machine according to the present invention is applied to rake a mass of hay, or other agricultural product, and to form a relative swath.

The agricultural machine according to the invention comprises at least a frame having a first part able to be connected to a traction means, such as for example a tractor or other, and at least a second part connected to the first part.

The agricultural machine also comprises a plurality of operating tools mounted rotatably on the second part, each of which is positioned so as to define a determinate angle of incidence with respect to the ground, to carry out a desired thrust action on the mass of hay.

According to a characteristic feature of the present invention, the agricultural machine comprises at least an adjustment device provided with at least a pivoting element constrained to the two parts of the frame and able to allow the selective rotation of the second part with respect to the first part, around an axis of pivoting substantially parallel to the ground, so as to selectively vary the amplitude of the angle of incidence of the operating tools with respect to the ground.

In this way, by rotating the second part of the frame with respect to the first part of the frame around the axis of rotation it is possible to vary the angle of incidence proportionately, and hence the operating action of the tools, according to the specific work conditions, without replacing the operating tools themselves.

The adjustment device according to the invention also comprises a movement member, provided with a first component attached to the first part of the frame and a second component constrained to the second part of the frame and mounted mobile on the first component, so as to be selectively moved in a controlled manner with respect thereto.

The selective movement of the second component with respect to the first component determines a corresponding rotation of the second part of the frame with respect to the first part of the frame, around the axis of pivoting, and hence said variation in the angle of incidence of the operating tools.

With the present invention we therefore have the possibility of adjusting the intensity of the thrust action on the hay by the operating tools, simply by moving in a controlled manner the second component with respect to the first component of the movement member of the device.

The movement of the two components, according to a first variant, can be actuated by a screw element solid with the second component and a mating threaded nut mounted rotatable on the first component.

According to another variant, the movement of the two components is actuated by a cam member.

According to other variants, the movement of the two components is actuated electronically, or pneumatically, or with another known mechanism.

According to a variant, at least two of the operating tools provided, advantageously the two disposed in succession in a terminal zone of the second part, are hinged to the second part of the frame so as to be selectively rotated with respect to the latter around a determinate axis of rotation, in order to assume angularly different positions with respect to the other tools.

According to a variant, the axis of rotation is substantially orthogonal to the axis of pivoting.

The two operating tools pivoted to the second part of the frame are connected to each other by a connecting lever, so that the rotation of the two is coordinated in a desired manner.

In this way, especially in the case of an agricultural machine with a V-shaped frame, or provided with two second parts disposed divergent from each other, it is possible to adjust effectively the width of the swath formed simply by rotating the terminal pairs of operating tools.

With this solution it is not necessary to dismantle or intervene on the frame so as to vary the sizes of the swath; it is enough to act in a targeted manner only on the operating tools involved in sizing the swath.

According to another variant, applicable to all the alternative solutions envisaged, each operating tool comprises a star-shaped wheel consisting of a plurality of radial teeth able to perform the elastic thrust on the hay.

In particular, each radial tooth is made of metal and has a determinate elasticity. The star-shaped wheel thus formed acts in a known manner on the hay to turn it over and rake it until it is piled up to form the swath.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a view from above of an agricultural machine for raking hay according to the present invention;

FIG. 2 is a three-dimensional view of an enlarged detail of the agricultural machine in FIG. 1;

FIG. 3 is a view from above of the detail in FIG. 2, in a first operating condition;

FIG. 4 is a section from IV to IV of FIG. 3;

FIG. 5 is a view from above of the detail in FIG. 2, in a second operating condition;

FIG. 6 is a section from VI to VI of FIG. 5;

FIG. 7 is a view from above of an enlarged detail of FIG. 1.

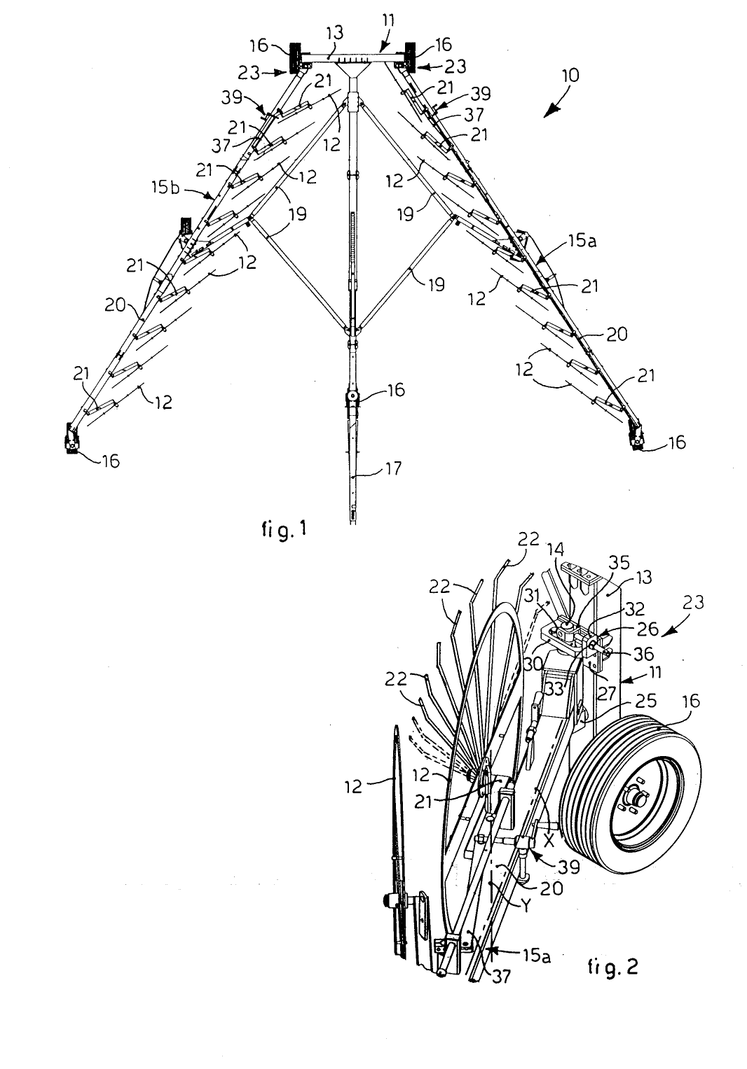

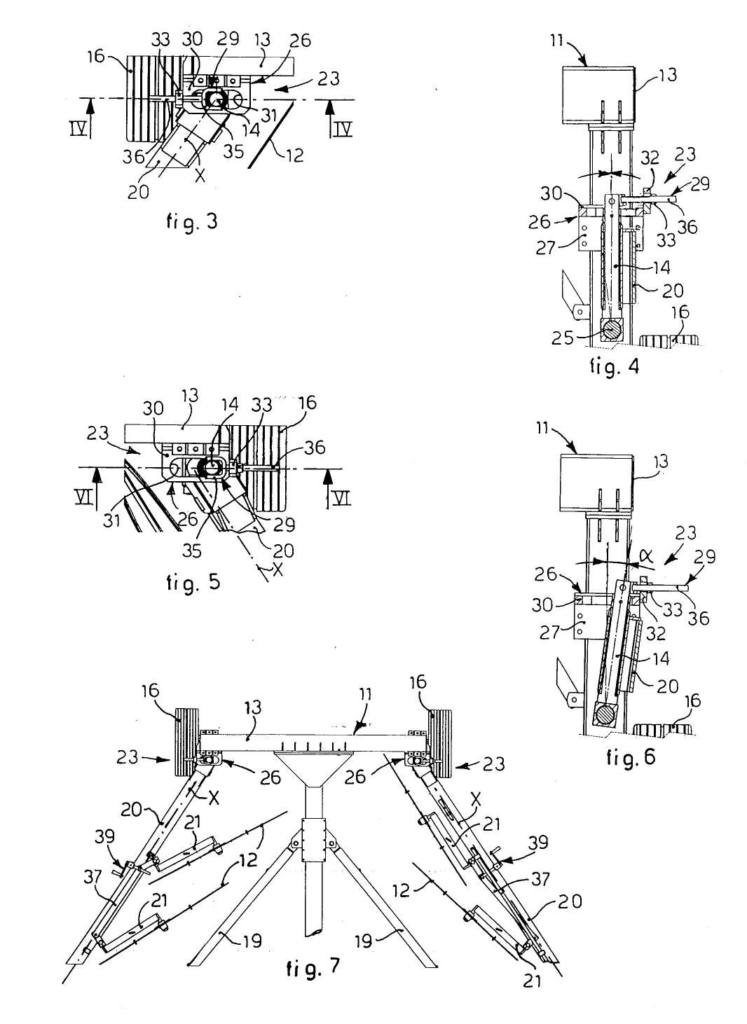

### DETAILED DESCRIPTION OF A PREFERENTIAL FORM OF EMBODIMENT

With reference to the attached drawings, an agricultural machine or swather 10 according to the present invention is able to be drawn by a tractor, of a known type and not shown here, to form a swath of hay.

The swather 10 comprises a trolley-like frame 11, on which a plurality of star-shaped wheels 12 are mounted, which perform an operating action of raking and turning over the hay so as to define the swath.

In particular, the frame 11 comprises a first part 13, substantially T-shaped, and a second part, in this case consisting of two arms, respectively 15a and 15b, articulated with respect to the first part 13 by means of a respective articulation pin 14.

The articulation pin 14 is disposed substantially vertical to allow the two arms 15a and 15b to be selectively moved along a substantially horizontal plane, between a first compact position in which they are substantially close up to the first part 13, and a second extended position, in which they are separated so as to form a substantial V shape.

The first part 13 comprises three wheels 16 that rest and run on the ground, and comprises a drawing hook 17 with which it can be attached to the tractor.

The first part 13 also comprises a group of levers 19, connected to each other in pantograph fashion, and constrained to the two arms 15a and 15b, in order to guide the movement of the latter between the compact and extended positions.

Each arm 15a and 15b comprises a supporting bar 20 having a first end hinged to the articulation pin 14 to define the articulation thereof to the first part 13, and a second end provided with a supporting and running wheel 16 analogous to those of the first part.

The supporting bar 20 of each arm 15a, 15b comprises a plurality, in this case nine, of brackets 21 disposed on its length, and on each of which a corresponding plurality of star-shaped wheels 12 are mounted rotatably. The brackets 21 are attached to the supporting bar 20 and keep the respective star-shaped wheels 12 with a determinate angle of incidence α with respect to the ground. In FIGS. 4 and 6 the angle α is defined as the angle formed between the vertical and the longitudinal axis of the pin 14.

Each star-shaped wheel 12 comprises a plurality of radial teeth 22 made of metal material with a determinate coefficient of elasticity, so as to perform a determinate elastic thrust action on the hay.

The swather 10 according to the present invention also comprises an adjustment device 23 mounted between the first part 13 and each supporting bar 20.

For each supporting bar 20 the adjustment device 23 comprises a horizontal pin 25 and a movement mechanism 26.

The horizontal pin 25 has a first end attached to the first part 13, a second end pivoted to the articulation pin 14, and is disposed so as to define an axis of pivoting X substantially parallel to the ground.

In this way, each supporting bar 20, being hinged on the articulation pin 14, can be selectively rotated with respect to the first part 13, around said axis of pivoting X.

As shown in FIGS. 4 and 6, the rotation of the supporting bar 20 determines a variation in the angle of incidence α of the star-shaped wheels 12, so as to vary the intensity of the elastic thrust action of the radial teeth 22 on the hay.

The movement member 26 comprises a first component 27 attached to the first part 12 of the frame 11, and a second component 29 constrained to the relative supporting bar 20 through the articulation pin 14, and mounted mobile on the first component 27.

In particular, the first component 27 comprises a metal block 30 attached to the first part 13. The metal block 30 is provided with an eyelet 31 conformed to house slidingly the upper end of the articulation pin 14 and a holed block 32, which supports rotatably a threaded nut 33.

The second component 29 comprises a fork element 35 which is articulated on one side to the upper end of the articulation pin 14 housed in the eyelet 31 and, on the other side, is provided with a threaded rod 36 screwed into the threaded nut 33.

In this way, by screwing or unscrewing the threaded nut 33 with respect to the threaded rod 36, the movement of the second component 29 is determined with respect to the first component 27 and, consequently, of the articulation pin 14 with respect to the eyelet 31.

Since the articulation pin 14 is hinged to the horizontal pin 25, its movement with respect to the eyelet 31 is embodied in a rotation around the axis of pivoting X, with consequent rotation of the supporting bar 20 around the same axis of pivoting X.

As we said, the rotation determines a variation in the angle of incidence α of the star-shaped wheels 12 with respect to the ground, varying the intensity of their elastic thrust action on the hay.

In this case, the last two brackets 21 of each supporting bar 20 are hinged to the supporting bar 20 itself, with respect to an axis of rotation Y substantially orthogonal to the axis of pivoting X.

In this way, the corresponding star-shaped wheels 12 can be rotated as desired with respect to the relative supporting bar 20, defining, with the corresponding star-shaped wheels 12 of the other bar 20, the maximum width of the swath formed.

Advantageously, the last two brackets 21 of each supporting bar 20 are connected to each other by a relative connecting lever 37, so that the rotation thereof with respect to the supporting bar 20 is coordinated as desired.

In this case, a crank device 39 is kinematically associated with each connecting lever 37, which allows to command the rotation of the brackets 21 and the star-shaped wheels 12, and hence the width of the swath formed.

It is clear, however, that modifications and/or additions of parts may be made to the agricultural machine 10 as described heretofore, without departing from the field and scope of the present invention.

For example, it comes within the field of the present invention to provide that one or the other or both of the movement mechanism 29 of the adjustment device 23 and the crank device 39 are commanded electronically, pneumatically or have other actuation mechanisms, for example cams, levers or other.

According to a variant, for each supporting bar 20 three or more hinged brackets 21 are provided. In this solution, the connecting lever 37 is connected to all the brackets 21 involved in the rotation.

Alternatively, several connecting levers 37 are provided, with possible relative crank devices 39, able to connect the brackets 21 in different combinations.

According to another variant, the supporting bars 20 and/or the first part 13 of the frame 11 are suitably articulated, to allow maximum flexibility and adhesion to the ground of the machine 10, even when the ground is uneven.

According to another variant, the horizontal pin 25 is connected on one side to the first part 13 and on the other side directly pivoted axially to the relative supporting bar 20.

It also comes within the field of the present invention to provide that the second part of the frame comprises a single supporting bar 20.

It is also clear that, although the present invention has been described with reference to some specific examples, a person of skill in the art shall certainly be able to achieve many other equivalent forms of agricultural machine for raking an agricultural product, having the characteristics as set forth in the claims and hence all coming within the field of protection defined thereby.

1. An agricultural machine for raking an agricultural product, comprising at least a frame provided with a first part able to be connected to a drawing means, and at least a second part connected to said first part, and able to support a plurality of operating tools of a rotary type, each of which is positioned so as to define a determinate angle of incidence (α) with respect to the ground, in order to perform a determinate thrust action on said agricultural product, the machine also comprising at least an adjustment device provided with at least a pivoting member constrained both to said first part and also to said second part of said frame and able to allow the selective rotation of said second part with respect to said first part around an axis of pivoting (X) substantially parallel to the ground, so as to selectively vary the amplitude of said angle of incidence (α) of said operating tools with respect to the ground.

2. The agricultural machine as in claim 1, wherein said adjustment device also comprises a movement member provided with a first component attached to said first part of said frame and a second component constrained to said second part of said frame and mounted mobile on said first component, and able to be selectively moved in a controlled manner with respect to said first component.

3. The agricultural machine as in claim 2, wherein the movement of said second component with respect to said first component is actuated by a screw element solid with said second component and a mating threaded element mounted rotatable on said first component.

4. The agricultural machine as in claim 2, wherein the movement of said second component with respect to said first component is actuated by a cam member.

5. The agricultural machine as in claim 2, wherein the movement of said second component with respect to said first component is actuated electronically or pneumatically.

6. The agricultural machine as in claim 2, wherein said first component comprises a metal block attached to said first part and provided with an eyelet with respect to which said second component runs and with a holed block, which holed block rotatably supports said threaded element.

7. The agricultural machine as in claim 2, wherein said second component comprises a fork element, which is articulated on one side to said second part and on the other side is provided with said threaded rod.

8. The agricultural machine as in claim 1, wherein said pivoting member comprises a pin having a first end attached to said first part and a second end pivoted to said second part so as to define said axis of pivoting (X).

9. The agricultural machine as in claim 8, wherein said second part is articulated with respect to said first part by means of an articulation pin, and wherein said pin has a first end attached to said first part and a second end pivoted to said articulation pin.

10. The agricultural machine as in claim 1, wherein at least two of said operating tools are hinged to said second part of said frame, so as to be able to be selectively rotated with respect to the latter around a determinate axis of rotation (Y), to assume angularly different positions with respect to the other operating tools.

11. The agricultural machine as in claim 10, wherein said axis of rotation (Y) is substantially orthogonal to said axis of pivoting (X).

12. The agricultural machine as in claim 10, wherein said two operating tools pivoted to said second part are connected to each other by means of a connecting lever, so as to coordinate the rotation thereof.
